(19) United States
(12) Patent Application Publication
(10) Pub. No.: US 2026/0087146 A1
(43) Pub. Date: Mar. 26, 2026

(54) SYSTEM AND METHOD FOR ENABLING AUTOMATED THREAT MODEL ASSESSMENT

(71) Applicant: The Toronto-Dominion Bank, Toronto (CA)

(72) Inventors: Benjamin AVDICEVIC, Mississauga (CA); Vasile Adrian GRIGORE, Richmond Hill (CA)

(21) Appl. No.: 19/046,966

(22) Filed: Feb. 6, 2025

Related U.S. Application Data
(60) Provisional application No. 63/697,775, filed on Sep. 23, 2024.

(51) Int. Cl. G06F 21/57

(52) U.S. Cl. CPC G06F 21/577; G06F 2221/033

(57) ABSTRACT

Computing platforms, methods, and storage media for enabling automated threat model assessment for a software solution are disclosed. Exemplary implementations may: obtain software architecture data from a software design tool, the software architecture data associated with design and deployment of the software solution; create, based on the obtained software architecture data, integration data comprising a subset of the software architecture data that is relevant to threat modeling, the integration data formatted for import by a threat assessment tool as threat assessment input data; and provide, to the threat assessment tool, access to the integration data for use in automated threat assessment, reducing time and effort in processing. Exemplary implementations may provide, as an input to a large language model (LLM), a data mapping of stored mapping relationships between software architecture data objects and threat assessment data objects; and obtain, as an output of the large language model, the translation blueprint.

### CROSS-REFERENCE TO RELATED APPLICATIONS

This application claims priority from U.S. Provisional Ser. No. 63/697,775, filed Sep. 23, 2024, the entirety of which is herein incorporated by reference.

### FIELD

The present disclosure relates to computing, including but not limited to computing platforms, methods, and storage media for enabling automated threat model assessment for a software solution.

### BACKGROUND

When creating a software solution, a solution architect may use a tool for architecture solution designs. Such tools may include a collaborative platform such as Hopex. After the solution has been designed, it can be desirable for the designed solution to be assessed with respect to potential security threats.

A threat modeler is tool that may be used for threat model assessment. A security architect may review the architecture design created by the solution architect which may take several meetings and days to complete. After that, the solution architect may create a threat model in the threat modeler tool and complete the threat modeler assessment. However, this threat modeling process can take days to complete, in addition to the meetings between the solution architect and the security architect to gather the data for creating the threat model.

Improvements in approaches threat model assessment for a software solution are desirable.

### BRIEF DESCRIPTION OF THE DRAWINGS

Embodiments of the present disclosure will now be described, by way of example only, with reference to the attached Figures.

FIG. 1 illustrates a system configured for enabling automated threat model assessment for a software solution, in accordance with one or more embodiments.

FIG. 2 illustrates a system configured for enabling automated threat model assessment for a software solution, in accordance with one or more embodiments.

FIG. 3 illustrates a method for enabling automated threat model assessment for a software solution, in accordance with one or more embodiments.

FIG. 4 is a block and flow diagram illustrating a system, in accordance with one or more embodiments.

FIG. 5 illustrates a high-level data model mapping, in accordance with one or more embodiments.

FIG. 6 illustrates a mapping of design data to threat modeler data, in accordance with one or more embodiments.

FIG. 7A and FIG. 7B illustrate a user interface output illustrating design data for import into a threat modeling tool according to one or more embodiments of the present disclosure.

FIG. 8 illustrates a sample application deployment architecture, in accordance with one or more embodiments.

FIG. 9A and FIG. 9B illustrate data collected via a custom tree structure, in accordance with one or more embodiments.

FIG. 10 illustrates a sample application deployment architecture, in accordance with one or more embodiments.

FIGS. 11A, 11B and 11C illustrate data collected via a custom tree structure, in accordance with one or more embodiments.

FIG. 12 illustrates an example of created integration data, in accordance with one or more embodiments.

### DETAILED DESCRIPTION

Computing platforms, methods, and storage media for enabling automated threat model assessment for a software solution are disclosed. Exemplary implementations may: obtain software architecture data from a software design tool, the software architecture data associated with design and deployment of the software solution; create, based on the obtained software architecture data, integration data comprising a subset of the software architecture data that is relevant to threat modeling, the integration data formatted for import by a threat assessment tool as threat assessment input data; and provide, to the threat assessment tool, access to the integration data for use in automated threat assessment.

Embodiments of the present disclosure provide a platform to automatically map design data to a threat modeler tool to enable automation of threat assessment and reduce time and effort in processing.

Embodiments of the present disclosure provide a system to automatically map data from a Hopex design tool used by a solution designer, to a Threat Modeler used by a security architect. The Hopex data may be extracted and mapped to a format understood by the threat modeler tool. The threat modeler may then use the imported and translated Hopex data to perform integrated threat modeling that is performed automatically and more quickly than known approaches.

There is a technical problem associated with known approaches in that a first person (solution architect) must provide data about the architecture design, and a second person (security architect) must understand that data and create a threat model for use in a threat modeling tool. This approach is inefficient and prone to errors, and includes manual steps that rely on a person's availability and/or skill. Embodiments of the present disclosure provide a technical solution by extracting data about the software solution, and creating integration data, such as an export file, based on the extracted data, where the integration data is created in a format that is usable by the threat modeling tool.

There is a further technical problem that even if a first tool for software design could communicate directly with a second tool for threat modeling, the tools use different data models and are not intended to work together. Embodiments of the present disclosure provide a technical solution by providing a data mapping file to be used as a basis for creating the integration data based on a subset of the available data that is relevant to threat assessment, and may be formatted for the threat assessment data model. This achieves interoperability between two tools that were not previously in a position to interoperate, which in turn introduces improvements in the operation of a computer operating the threat modeling tool, since the threat modeling and assessment can be performed more efficiently using the properly formatted integration data, which was not previously available, and which work needed to be performed manually by two people.

One aspect of the present disclosure relates to a computing platform configured for enabling automated threat model assessment for a software solution. The computing platform may include a non-transient computer-readable storage medium having executable instructions embodied thereon. The computing platform may include one or more hardware processors configured to execute the instructions. The processor(s) may execute the instructions to obtain software architecture data from a software design tool, the software architecture data being associated with the design and deployment of the software solution. The processor(s) may execute the instructions to create, based on the obtained software architecture data, integration data comprising a subset of the software architecture data that is relevant to threat modeling, the integration data being formatted for import by a threat assessment tool as threat assessment input data. The processor(s) may execute the instructions to provide, to the threat assessment tool, access to the integration data for use in automated threat assessment.

Another aspect of the present disclosure relates to a method for enabling automated threat model assessment for a software solution. The method may include obtaining software architecture data from a software design tool, the software architecture data associated with the design and deployment of the software solution. The method may include creating, based on the obtained software architecture data, integration data comprising a subset of the software architecture data that is relevant to threat modeling, the integration data formatted for import by a threat assessment tool as threat assessment input data. The method may include providing, to the threat assessment tool, access to the integration data for use in automated threat assessment.

Yet another aspect of the present disclosure relates to a non-transient computer-readable storage medium having instructions embodied thereon, the instructions being executable by one or more processors to perform a method for enabling automated threat model assessment for a software solution. The method may include obtaining software architecture data from a software design tool, the software architecture data associated with the design and deployment of the software solution. The method may include creating, based on the obtained software architecture data, integration data comprising a subset of the software architecture data that is relevant to threat modeling, the integration data formatted for import by a threat assessment tool as threat assessment input data. The method may include providing, to the threat assessment tool, access to the integration data for use in automated threat assessment.

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

Certain terms used in this application and their meaning as used in this context are set forth in the description below. To the extent a term used herein is not defined, it should be given the broadest definition persons in the pertinent art have given that term as reflected in at least one printed publication or issued patent. Further, the present processes are not limited by the usage of the terms shown below, as all equivalents, synonyms, new developments and terms or processes that serve the same or a similar purpose are considered to be within the scope of the present disclosure.

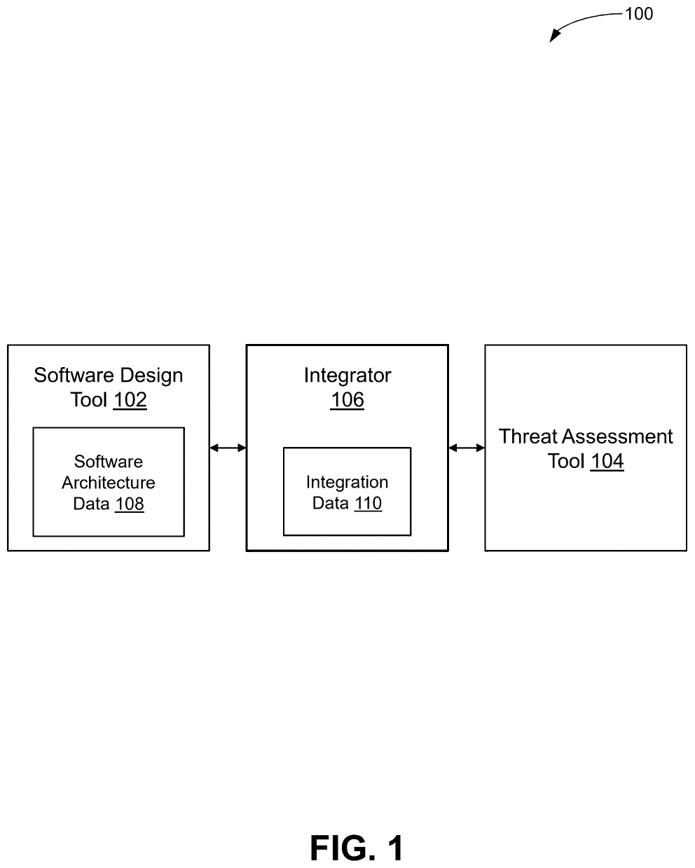

FIG. 1 illustrates a system 100 configured for enabling automated threat model assessment for a software solution, in accordance with one or more embodiments. The system 100 may comprise a software design tool 102, a threat assessment tool 104, and an integrator 106. The integrator 106 may include one or more hardware processors configured by machine-readable instructions to perform one or more of the functions or features described herein. The integrator 106 may be configured to obtain software architecture data 108 from the software design tool 102. The software architecture data may be associated with design and deployment of the software solution. The integrator 106 may be configured to create, based on the obtained software architecture data 108, integration data 110 comprising a subset of the software architecture data that is relevant to threat modeling, which may in an example implementation comprise only a subset of the software data that is relevant to threat modeling. The integration data may be formatted for import by the threat assessment tool 104 as threat assessment input data. The integrator 106 may be configured to provide, to the threat assessment tool 104, access to the integration data 110 for use in automated threat assessment.

In some implementations of the system 100, the integrator 106 may be configured to obtain a data extraction blueprint for extracting the subset of the software architecture data 108. The integrator 106 may be configured to create the integration data based on the obtained software architecture data 108 and based on the data extraction blueprint. The data extraction blueprint may define the subset of the software architecture data 108 that is relevant to threat modeling.

In some implementations of the system 100, the software architecture data 108 may comprise first architecture data sufficient to create a first software architecture in the software design tool 102 associated with the design and deployment of the software solution. The integration data 110 may comprise second architecture data sufficient to re-create the first software architecture in the threat assessment tool 104 associated with the design and deployment of the software solution. In an example implementation, the first and second software architectures may comprise or be represented by first and second software architecture layouts, or by first and second software architecture diagrams.

In some implementations of the system 100, the integrator 106 may be configured to create an integration file comprising the integration data. In some implementations of the system 100, the integrator may be configured to provide access to the integration file. The integration file may be provided in a comma separated variable (CSV) format. In some implementations of the system, the integrator 106 may be configured to provide access to the integration data via an application programming interface (API) data query. The API data query may comprise a GraphQL query, and the integration data may comprise a GraphQL schema.

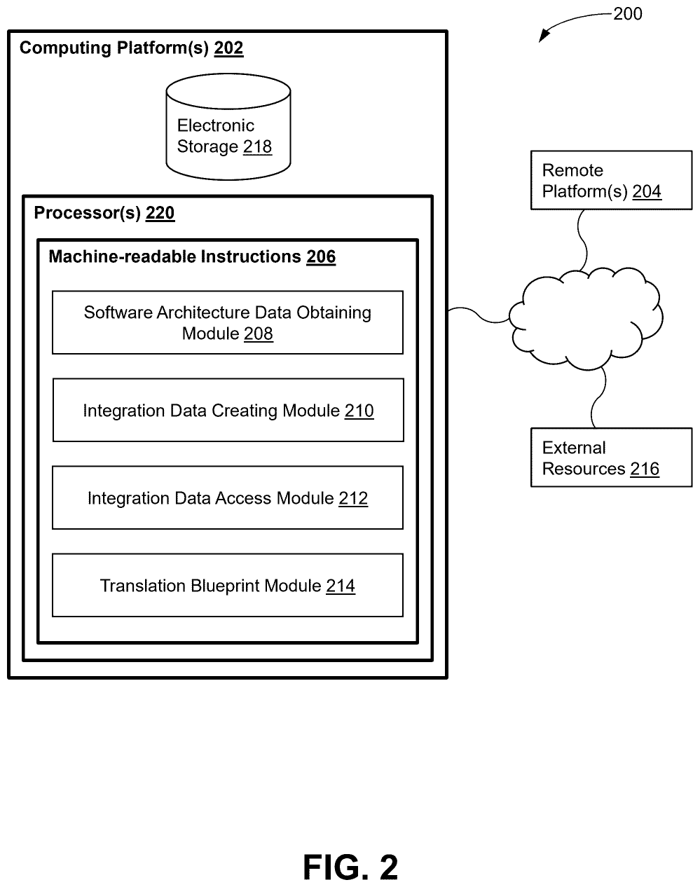

FIG. 2 illustrates a system 200 configured for enabling automated threat model assessment for a software solution, in accordance with one or more embodiments. In some embodiments, system 200 may include one or more computing platforms 202. Computing platform(s) 202 may be configured to communicate with one or more remote platforms 204 according to a client/server architecture, a peer-to-peer architecture, and/or other architectures. Remote platform(s) 204 may be configured to communicate with other remote platforms via computing platform(s) 202 and/or according to a client/server architecture, a peer-to-peer architecture, and/or other architectures. Users may access system 200 via remote platform(s) 204.

Computing platform(s) 202 may be configured by machine-readable instructions 206. Machine-readable instructions 206 may include one or more instruction modules. The instruction modules may include computer program modules. The instruction modules may include one or more of software architecture data obtaining module 208, integration data creating module 210, integration data access module 212, data extraction blueprint obtaining module 214, and/or other instruction modules.

Software architecture data obtaining module 208 may be configured to obtain software architecture data from a software design tool. The software architecture data may be associated with the design and deployment of the software solution. The software architecture data may include first architecture data sufficient to create a first software architecture in the software design tool associated with the design and deployment of the software solution. Software architecture data obtaining module 208 may be configured to obtain a data extraction blueprint for extracting the subset of the software architecture data. Software architecture data obtaining module 208 may be configured to create the integration data based on the obtained software architecture data and based on the data extraction blueprint. The data extraction blueprint may define the subset of the software architecture data that is relevant to threat modeling.

In an example embodiment, software architecture data obtaining module 208 may be in communication with, or may comprise, an artificial intelligence (AI) tool which may include a machine learning tool or a large language model. Such an AI tool may be used to generate the data extraction blueprint, and may define the subset of software architecture data that is relevant to threat modeling, for example based on input parameters that identify different types of software architecture data that are known to be relevant to threat modeling.

To ensure that the system is configured to handle software architecture updates, software architecture data obtaining module 208 may be configured to: obtain updated software architecture data from the software design tool, where the updated software architecture data is associated with design and deployment of an updated version of the software solution. Software architecture data obtaining module 208 may be configured to create, based on the obtained updated software architecture data. The updated integration data may comprise a subset of the updated software architecture data that is relevant to threat modeling.

Integration data creating module 210 may be configured to create, based on the obtained software architecture data, integration data comprising a subset of the software architecture data that is relevant to threat modeling. The integration data may be formatted for import by a threat assessment tool as threat assessment input data. The integration data may include second architecture data sufficient to re-create the first software architecture in the threat assessment tool associated with the design and deployment of the software solution.

Integration data creating module 210 may be configured to obtain a data extraction blueprint for extracting the subset of the software architecture data.

Integration data access module 212 may be configured to provide, to the threat assessment tool, access to the integration data for use in automated threat assessment. Integration data access module 212 may be configured to provide access to the integration data via an application programming interface (API) data query. The API data query may include a GraphQL query, and the integration data may include a GraphQL schema. Integration data access module 212 may be configured to create an integration file comprising the integration data. Integration data access module 212 may be configured to provide access to the integration file. The integration file may be provided in a comma separated variable (CSV) format.

Translation blueprint module 214 may be configured to obtain a translation blueprint for translating the software architecture data to the threat assessment input data. Translation blueprint module 214 may be configured to provide the translation blueprint to the threat assessment tool for translating the software architecture data to the threat assessment input data. While the data extraction blueprint may define the subset of the software architecture data that is relevant to threat modeling, the translation blueprint may define data mapping or data transformation to enable translation of software architecture data to threat assessment input data.

In an example embodiment, translation blueprint module 214 may be in communication with, or may comprise, an AI tool which may include a machine learning tool or a large language model. Such an AI tool may be used to generate the translation blueprint, and may define the data mapping. Translation blueprint module 214 may be configured to provide, as an input to a large language model (LLM), a data mapping of stored mapping relationships between software architecture data objects and threat assessment data objects; and obtain, as an output of the large language model, the translation blueprint. Translation blueprint module 214 may be configured to create, for example using a large language model, the translation blueprint based on a data mapping of stored mapping relationships between software architecture data objects and threat assessment data objects.

In some embodiments, computing platform(s) 202, remote platform(s) 204, and/or external resources 216 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 202, remote platform(s) 204, and/or external resources 216 may be operatively linked via some other communication media.

A given remote platform 204 may include one or more processors configured to execute computer program modules. The computer program modules may be configured to enable an expert or user associated with the given remote platform 204 to interface with system 200 and/or external resources 216, and/or provide other functionality attributed herein to remote platform(s) 204. By way of non-limiting example, a given remote platform 204 and/or a given computing platform 202 may include one or more of a server, a desktop computer, a laptop computer, a handheld computer, a tablet computing platform, a NetBook, a Smartphone, a gaming console, and/or other computing platforms.

External resources 216 may include sources of information outside of system 200, external entities participating with system 200, and/or other resources. In some embodiments, some or all of the functionality attributed herein to external resources 216 may be provided by resources included in system 200.

Computing platform(s) 202 may include electronic storage 218, one or more processors 220, and/or other components. Computing platform(s) 202 may include communication lines, or ports to enable the exchange of information with a network and/or other computing platforms. Illustration of computing platform(s) 202 in FIG. 2 is not intended to be limiting. Computing platform(s) 202 may include a plurality of hardware, software, and/or firmware components operating together to provide the functionality attributed herein to computing platform(s) 202. For example, computing platform(s) 202 may be implemented by a cloud of computing platforms operating together as computing platform(s) 202.

Electronic storage 218 may comprise non-transitory storage media that electronically stores information. The electronic storage media of electronic storage 218 may include one or both of system storage that is provided integrally (i.e., substantially non-removable) with computing platform(s) 202 and/or removable storage that is removably connectable to computing platform(s) 202 via, for example, a port (e.g., a USB port, a firewire port, etc.) or a drive (e.g., a disk drive, etc.). Electronic storage 218 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 218 may include one or more virtual storage resources (e.g., cloud storage, a virtual private network, and/or other virtual storage resources). Electronic storage 218 may store software algorithms, information determined by processor(s) 220, information received from computing platform(s) 202, information received from remote platform(s) 204, and/or other information that enables computing platform(s) 202 to function as described herein.

Processor(s) 220 may be configured to provide information processing capabilities in computing platform(s) 202. As such, processor(s) 220 may include one or more of a digital processor, an analog processor, a digital circuit designed to process information, an analog circuit designed to process information, a state machine, and/or other mechanisms for electronically processing information. Although processor(s) 220 is shown in FIG. 2 as a single entity, this is for illustrative purposes only. In some embodiments, processor(s) 220 may include a plurality of processing units. These processing units may be physically located within the same device, or processor(s) 220 may represent processing functionality of a plurality of devices operating in coordination. Processor(s) 220 may be configured to execute modules 208, 210, 212, and/or 214, and/or other modules. Processor(s) 220 may be configured to execute modules 208, 210, 212, and/or 214, and/or other modules by software; hardware; firmware; some combination of software, hardware, and/or firmware; and/or other mechanisms for configuring processing capabilities on processor(s) 220. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 208, 210, 212, and/or 214 are illustrated in FIG. 2 as being implemented within a single processing unit, in embodiments in which processor(s) 220 includes multiple processing units, one or more of modules 208, 210, 212, and/or 214 may be implemented remotely from the other modules. The description of the functionality provided by the different modules 208, 210, 212, and/or 214 described below is for illustrative purposes, and is not intended to be limiting, as any of modules 208, 210, 212, and/or 214 may provide more or less functionality than is described. For example, one or more of modules 208, 210, 212, and/or 214 may be eliminated, and some or all of its functionality may be provided by other ones of modules 208, 210, 212, and/or 214. As another example, processor(s) 220 may be configured to execute one or more additional modules that may perform some or all of the functionality attributed below to one of modules 208, 210, 212, and/or 214.

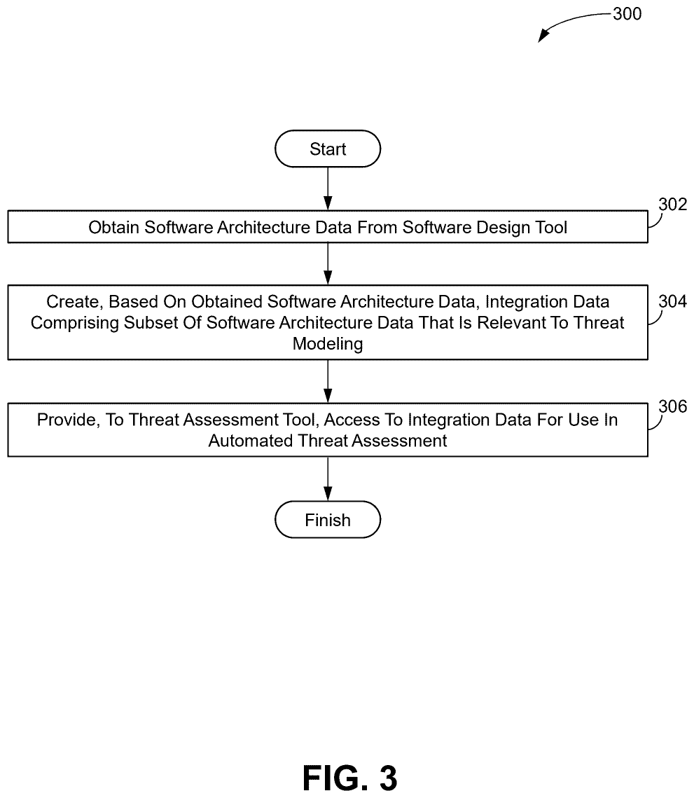

FIG. 3 illustrates a method 300 for enabling automated threat model assessment for a software solution, in accordance with one or more embodiments. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

An operation 302 may include obtaining software architecture data from a software design tool, the software architecture data associated with design and deployment of the software solution. Operation 302 may be performed by one or more hardware processors configured by machine-readable instructions including a module that is the same as or similar to software architecture data obtaining module 208, in accordance with one or more embodiments.

An operation 304 may include creating, based on the obtained software architecture data, integration data comprising a subset of the software architecture data that is relevant to threat modeling, the integration data formatted for import by a threat assessment tool as threat assessment input data. Operation 304 may be performed by one or more hardware processors configured by machine-readable instructions including a module that is the same as or similar to integration data creating module 210, in accordance with one or more embodiments.

An operation 306 may include providing, to the threat assessment tool, access to the integration data for use in automated threat assessment. Operation 306 may be performed by one or more hardware processors configured by machine-readable instructions including a module that is the same as or similar to integration data access module 212, in accordance with one or more embodiments.

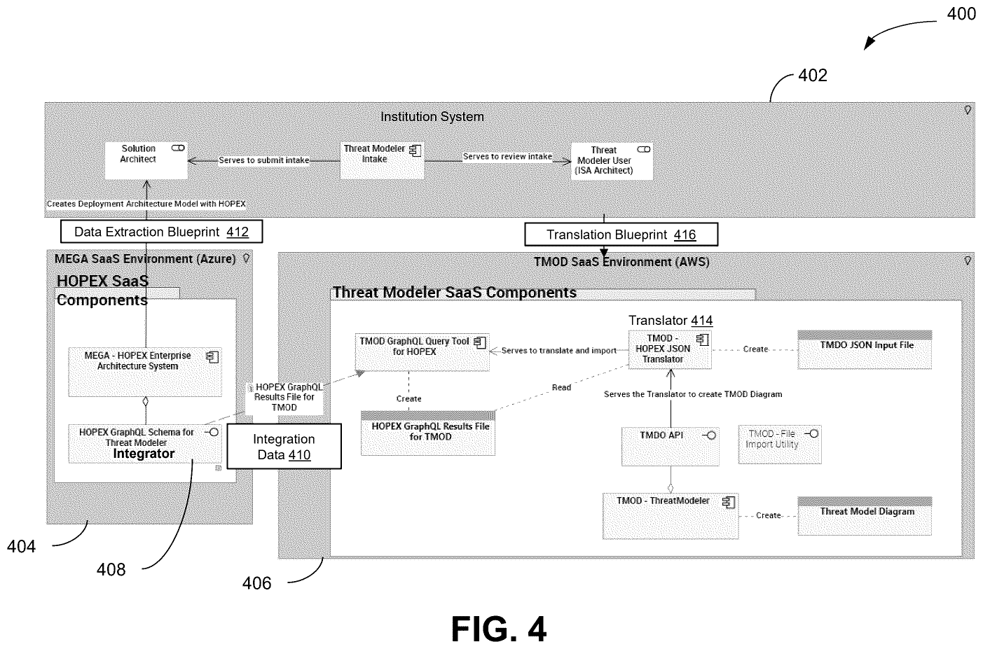

FIG. 4 is a block and flow diagram illustrating a system 400 according to one or more embodiments of the present disclosure. An institution system 402 may be in communication with a first SaaS environment 404 (Hopex, for example hosted in Azure) and with a second SaaS environment 406 (Threat Modeler, or TMOD, for example hosted in AWS). A solution architect may use Hopex 404 to create architectures. The system 400 comprises an integrator 408 which, in an example embodiment, comprises a Hopex GraphQL Schema for Threat Modeler configured to collect data and provides the collected data to the TMOD system 406, for example as a GraphQL results file. The integrator 408 is configured to collect, via the Hopex system 404, very specific data that is used for the threat modeler application.

For example, the integrator 408 may be configured to obtain software architecture data from a software design tool, such as at 404, the software architecture data associated with design and deployment of the software solution. The integrator 408 may be configured to create, based on the obtained software architecture data, integration data 110 comprising a subset of the software architecture data that is relevant to threat modeling. The integration data 110 may be formatted for import by a threat assessment tool such as 406 as threat assessment input data. The integrator 408 may obtain a data extraction blueprint 412 for this schema, and the blueprint 412 may be used to operationalize an interface that is used to extract or obtain the integration data 110.

The data extraction blueprint 412, for example for GraphQL Schema, may provide the meta-mapping and the mapping, on the basis of which the integration data may be created. The integrator 408 may be configured to generate the integration data 110 as a Hopex GraphQL Results File for TMOD. In an implementation, there may be an integration element on the Hopex end in the first SaaS environment 404 and on the TMOD end in the second SaaS environment 406. The threat modeler application in the second SaaS environment 406 may be configured to trigger a data load, to import data for the design, for example via a query tool provided to pull the data from the results file. Since GraphQL functionality is already present in some Hopex implementations, a vendor operating a second SaaS environment 406 may be configured to properly query GraphQL using mapping that the institution system 402 provides to do the translation.

At the TMOD environment 406, a translator 414, such as TMOD-Hopex JSON Translator, may be configured to ingest the integration data file, and translate contents of the data file into the language of the data model that the threat modeler understands. The translator 414 may use an existing TMOD API, based on the properly formatted input file, making it a lot faster to assess the threats.

In an implementation, the institution system 402 may be configured to provide a translation blueprint 416. In such an implementation, the institution system 402 does not build the translator 414, but provides a translation blueprint 416 with details permitting an operator of the second SaaS environment 406 to map the integration data to build the translator 414. The vendor may build the translator 414 based on the translation blueprint 416 provided by the institution system 402. The institution system 402 may include translation data to translate the integration data from Hopex to TMOD. In another implementation, the institution system 402 may build the translator 414 based on the blueprint 416.

The second SaaS environment 406 may be configured to create a JSON file as output of the translator, for example from integration data 110 provided as a CSV file that is created as output from Hopex. The translator 414 may be configured to consume a data mapping file that the institution system 402 provides and maintains. The institution system 402 may be configured to create the translator 414 and directly call the APIs and directly call the threat model, based on stored data specifying how to create a request with proper JSON payload.

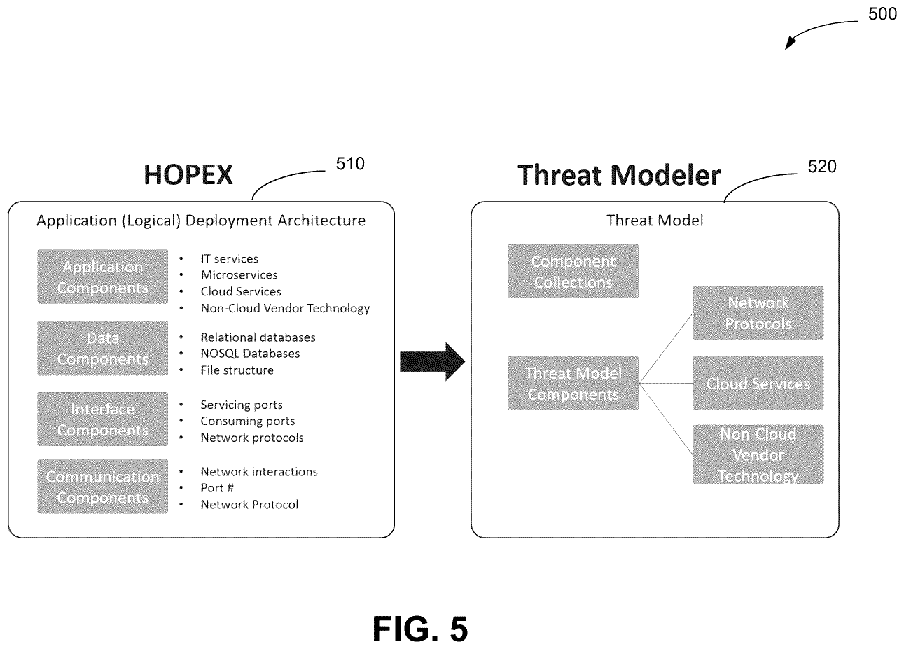

FIG. 5 illustrates a high-level data model mapping according to one or more embodiments of the present disclosure. FIG. 5 shows details of a high-level mapping between a Hopex application (logical) deployment architecture 510, and a TMOD threat modeler architecture 520. In 510, the application deployment architecture comprises: application components, such as IT services, microservices, cloud services, non-cloud vendor technology; data components, such as relational databases, NOSQL databases, and file structure; interface components, such as servicing ports, consuming ports, network protocols; and communication components, such as network interactions, port # and network protocol.

As shown in FIG. 5, in 520 the threat model comprises component collections, as well as threat model components, where the threat model components may comprise network protocols, cloud services and non-vendor technology. While there is some similarity between some of the components in 510 and 520, there are no direct matches at the same hierarchical level. For example, considering a tree structure of the architectures, in 510 the cloud services, non-cloud vendor technology and network protocols are at a different hierarchical tree level than in 520. Moreover, many of the elements do not have a direct counterpart, such that only some of the data in 510 may be relevant to a threat assessment by a threat modeler according to the architecture 520.

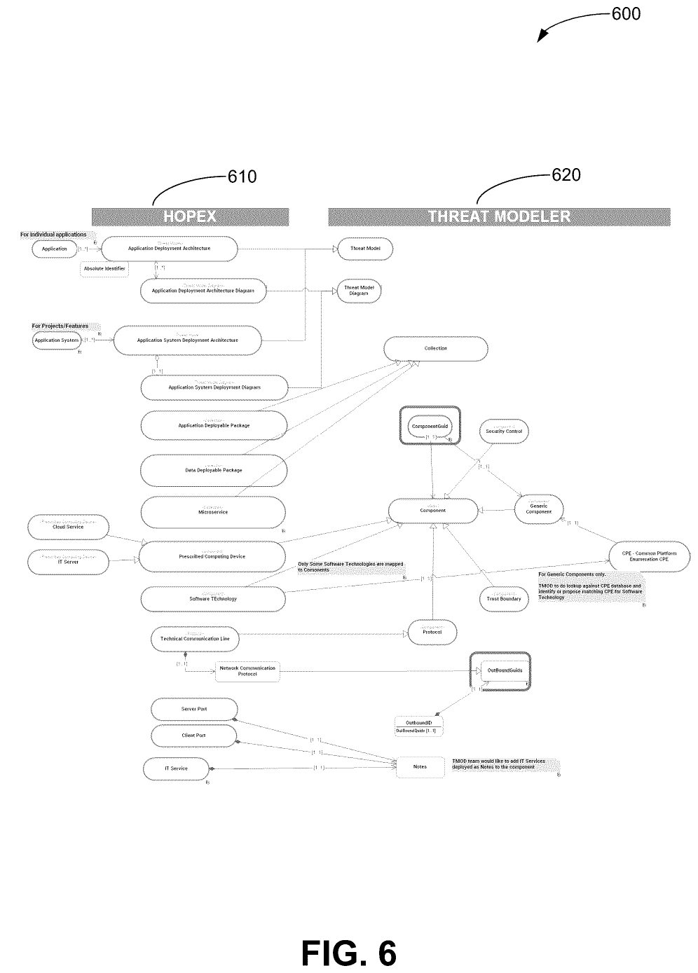

FIG. 6 illustrates a mapping 600 of design data 610 to threat modeler data 620 according to one or more embodiments of the present disclosure. At a high level, logical application deployment 610 may be mapped to a threat model 620 in accordance with an embodiment. A similar mapping may be provided for project or feature architectures, which may comprise a plurality of application. Similar mapping may also be done at the level of product in accordance with one or more embodiments. In an example implementation, the institution system may be configured to build, in Hopex, a tree structure such as 610 that may be used to create a visual representation of the architecture and its hierarchy. A root node may be provided as part of a diagram of the object, then components or data elements are provided inside the diagram.

As shown in FIG. 6, an application deployment architecture and application system deployment architecture in 610 may be mapped to a threat model in 620. An application deployment architecture diagram and application system deployment architecture in 610 may be mapped to a threat model diagram in 620. As another example, within the application system the elements of application deployment package, data deployable package and microservice in 610 may be mapped to a collection in 620. As a further example, server port, client port and IT service objects or components in 610 may be mapped to notes in 620.

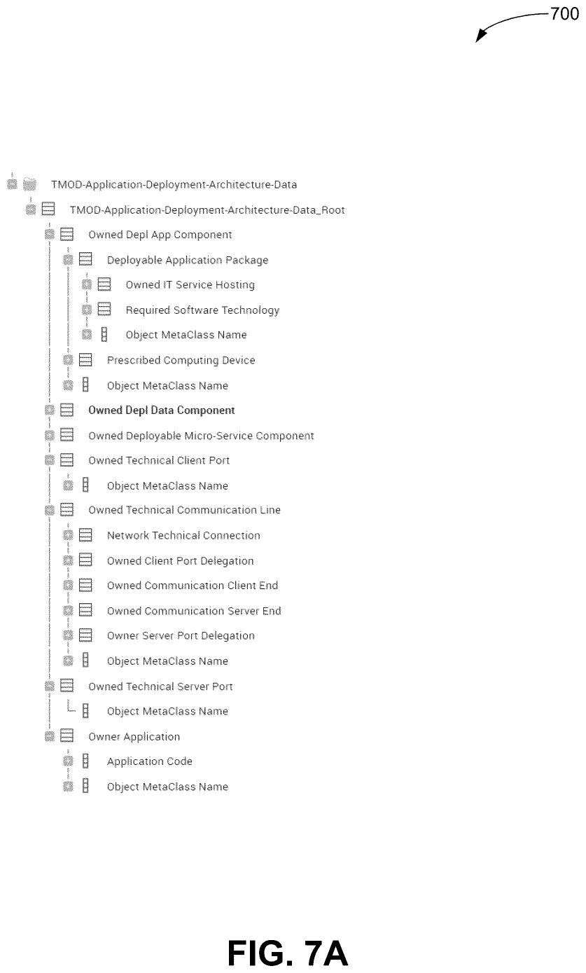

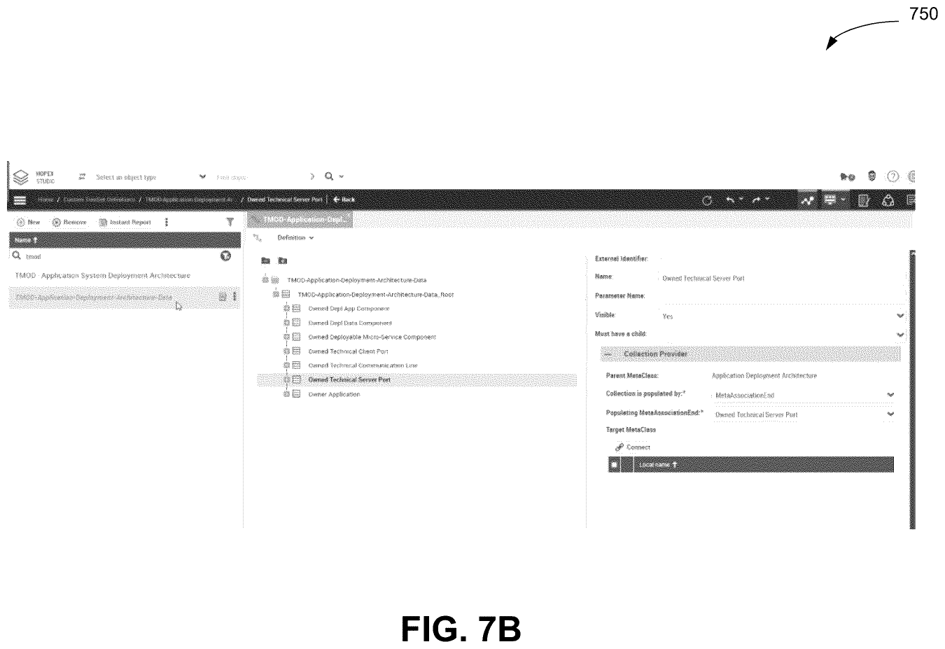

FIG. 7A and FIG. 7B illustrate user interface outputs illustrating design data for import into a threat modeling tool, in accordance with one or more embodiments. The user interface outputs of FIG. 7A and FIG. 7B include an example of a tree structure described above in relation to FIG. 6. FIG. 7A shows at 700 different levels of the tree structure at the application level, which may provide sufficient data to create an architecture diagram in the threat modeling tool. In the example of FIG. 7A, TMOD-Application-Deployment-Architecture-Data_Root is the parent or root of the tree structure or diagram object. A number of components or data elements may be provided inside the diagram. For example, the Owned Depl App Component in FIG. 7A includes the element Deployable Application Package, which itself includes 3 elements of: Owned IT Service Hosting, Required Software Technology, and Object MetaClass Name. The structure in FIG. 7A shows, for each particular application component, the types of data elements that should be obtained for inclusion in the integration data, since these data elements are important for building the diagram in the threat modeler. This information may be used to populate or define a data extraction blueprint in accordance with one or more embodiments.

With reference to FIG. 7A as well as to FIG. 4 and FIG. 5, a system according to one or more embodiments may be configured to create an Excel file that includes the data elements for creating an architecture diagram, then create a diagram in TMOD from the Excel. The system may be configured to create a service endpoint in Hopex using GraphQL, so that TMOD can obtain the info from GraphQL over internet. This approach may be implemented at the application level, or at product/project level. In an embodiment, the system may use the Excel file as the source of data. In another embodiment, a GraphQL interface may be provided that serves the same data.

FIG. 7B at 750 shows an example of further details for an example element of owned technical server port, where details may be provided such as: external identifier name, collection provider Parent Meta Class, collection populated by, populating Meta Association End, etc. Different elements, aspects, parameters or characteristics may be added or omitted depending on the details of the implementation.

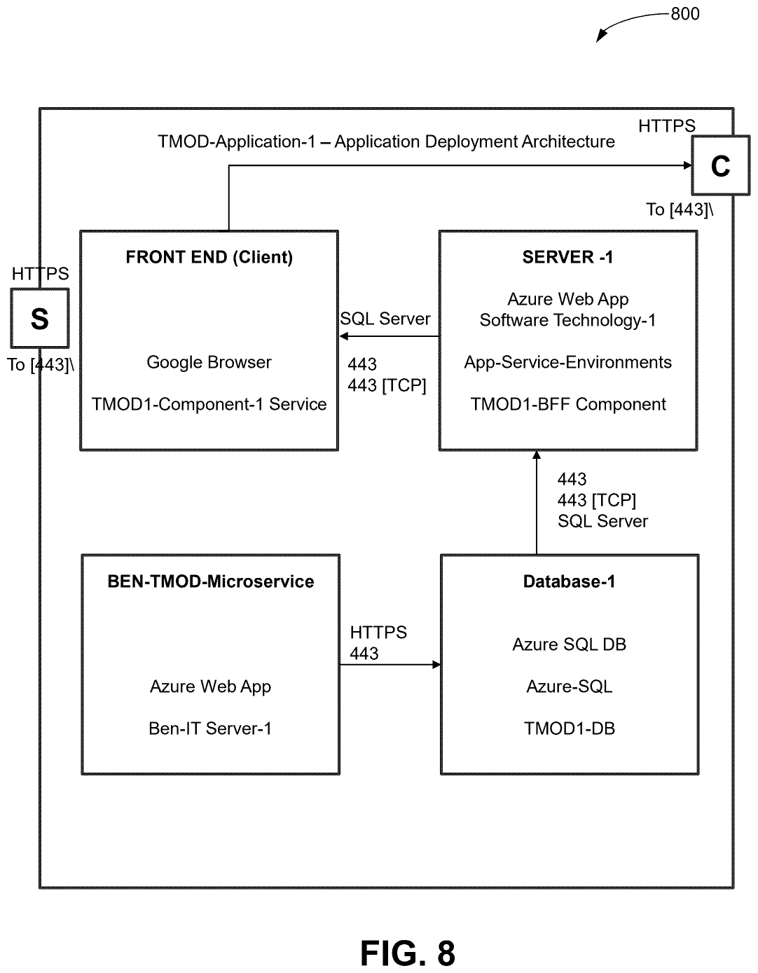

FIG. 8 illustrates a sample application deployment architecture 800 according to one or more embodiments. FIG. 8 shows an example of a design that an architect may create, for example in a software design tool. Data from the architecture shown in FIG. 8 may be collected with a custom built tree set function, for example TreeSet in Java™, such as shown in FIG. 7A and FIG. 7B and imported into the threat modeler application. All of the data elements that are identified as being important from a threat assessment perspective may be extracted, for example in a tree-like structure.

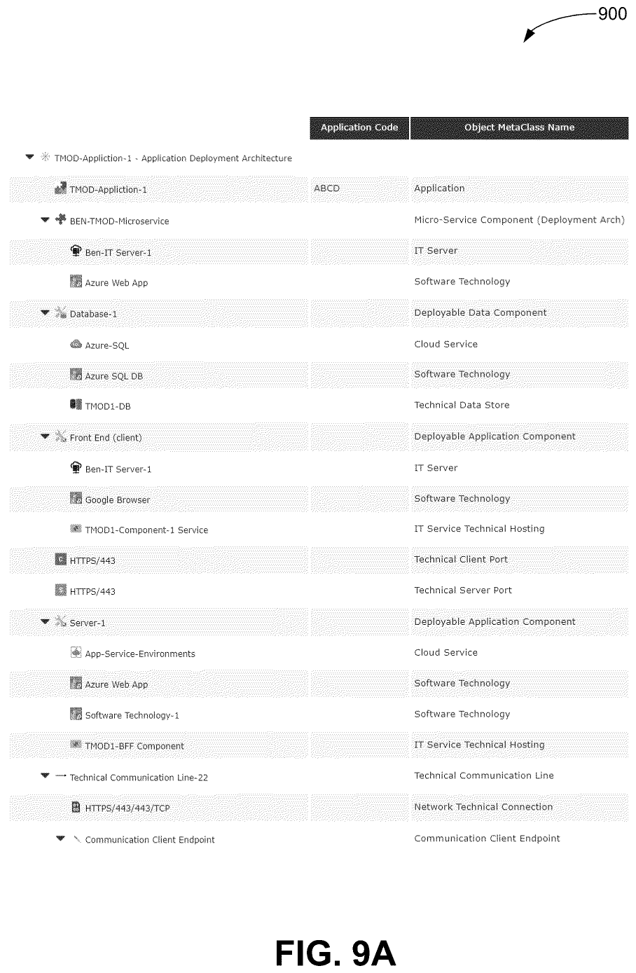

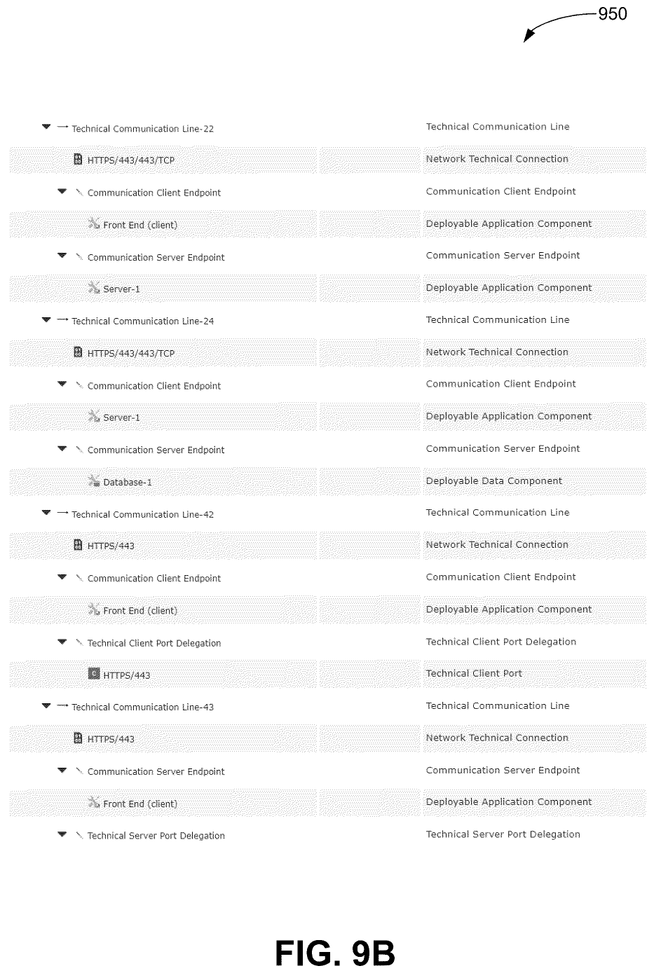

FIG. 9A and FIG. 9B illustrate data collected via a custom tree set function on accordance with one or more embodiments. The data shown at 900 in FIG. 9A and at 950 in FIG. 9B may comprise a partial data extract from a single application deployment architecture diagram, such as shown in FIG. 8. For example, the BEN TMOD Microservice element in FIG. 9A corresponds to the BEN TMOD Microservice element in the application deployment architecture of FIG. 8. The Azure Web App and BEN-IT Server-1 objects in FIG. 9A are also obtained from the application deployment architecture of FIG. 8.

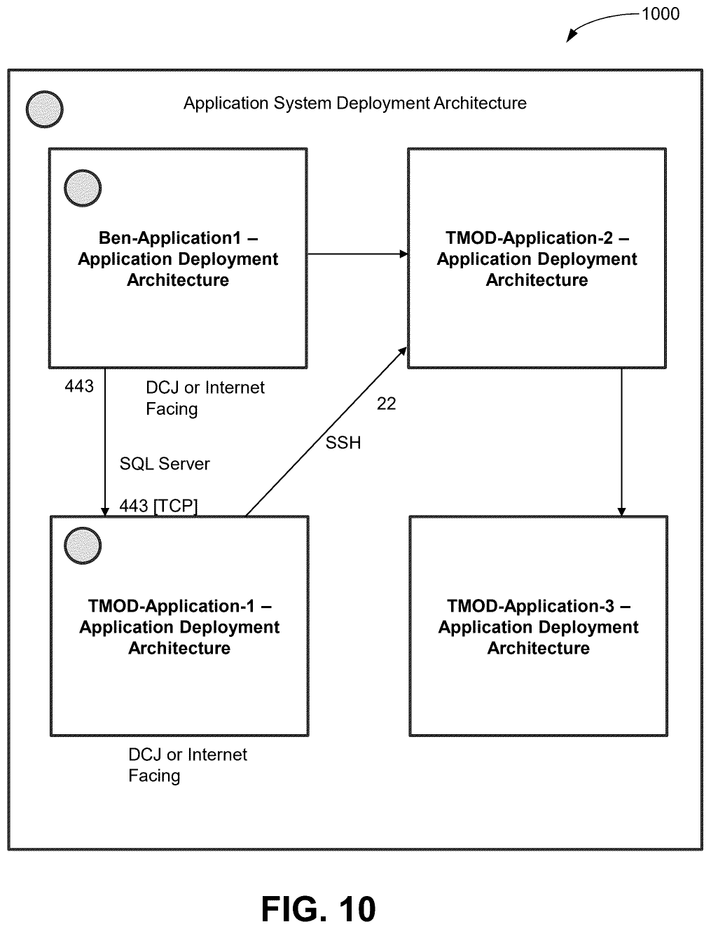

FIG. 10 illustrates a sample application deployment architecture 1000 in accordance with one or more embodiments of the present disclosure. While the architecture of FIG. 8 is for a single application, the architecture of FIG. 10 is for a plurality of applications. It can be important to know how applications connect with each other, to assess threat model of entire product/project. The application deployment architecture of FIG. 10 may be at the level of a project or a product, since it includes a plurality of applications. In a project, there may be a situation where two of the four applications are being updated. From a threat modeling perspective, it can be important to identify or determine how all of these applications connect with each other, and be able to assess the threat model of the entire system.

In accordance with one or more embodiments, a system is configured to obtain a multi-application data extraction blueprint, which follows the same principle, with a root object, as for the single application examples described earlier. For each application, the system uses the data extraction blueprint to collect or extract all of the data elements inside each application that are relevant to threat assessment. The system may then consolidate all of the data elements for all of the applications that are included in the architecture.

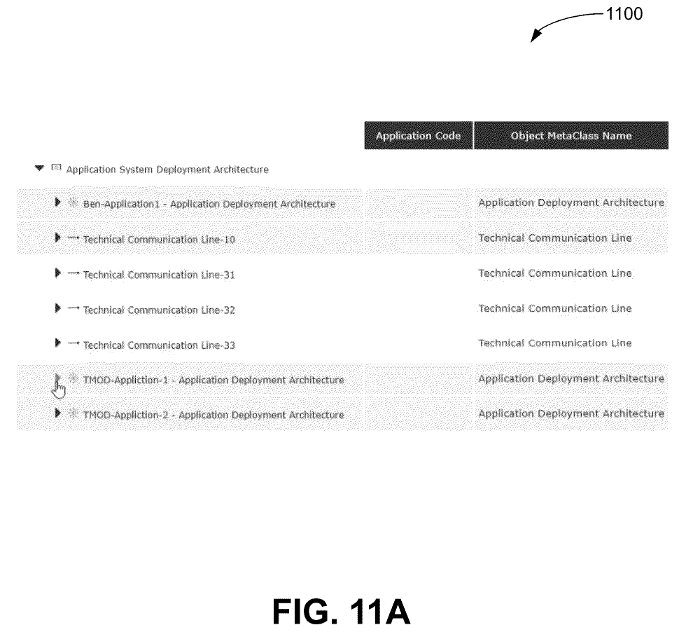

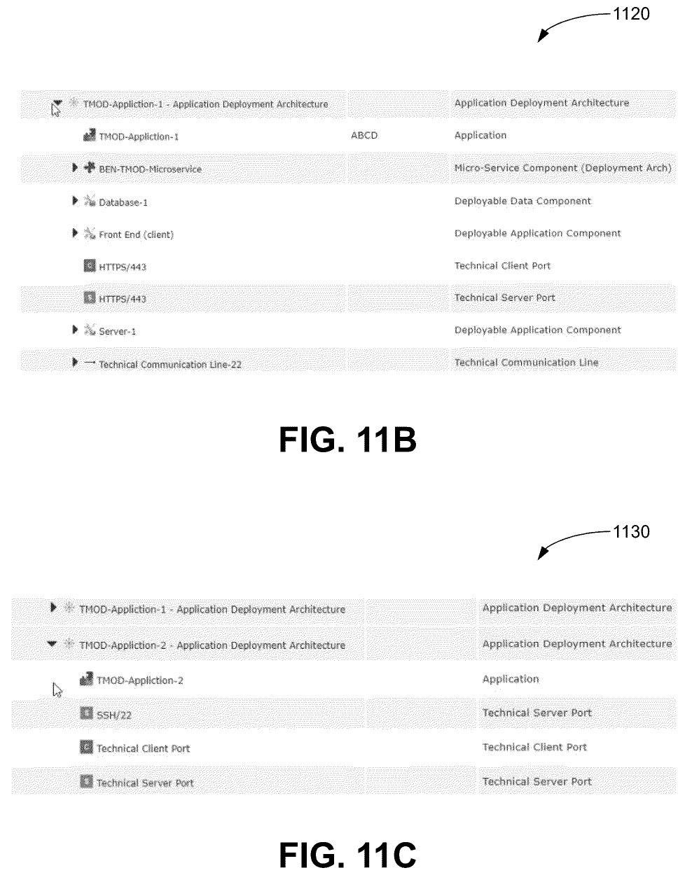

FIGS. 11A, 11B and 11C illustrate data collected via a custom tree set function according to one or more embodiments of the present disclosure, for an architecture that comprises a plurality of applications. The data shown in FIG. 11A and FIG. 11B may comprise a partial data extract from a multiple application deployment architecture diagram, such as shown in FIG. 10.

For example, at 1100 in FIG. 11A, the BEN-Application-1 Application Deployment Architecture, TMOD-Application-1 Application Deployment Architecture and TMOD-Application-2 Application Deployment Architecture are 3 of the application architecture boxes shown in FIG. 10. FIG. 11A also illustrates technical communication lines that may be present in the multiple application deployment of FIG. 10.

FIG. 11B at 1120 shows an expansion of the TMOD-Application-1 Application Deployment Architecture, and includes the following elements: TMOD-Application-1, BEN-TMOD Microservice, Database-2, Front End (client, which includes C HTTPS/443 and S HTTPS/443, as well as Server-1 and Technical Communication Line 22.

FIG. 11C at 1130 shows an expansion of the TMOD-Application-2 Application Deployment Architecture, and includes the following elements: TMOD-Application-2, SSH/22, Technical Client Port, and Technical Server Port.

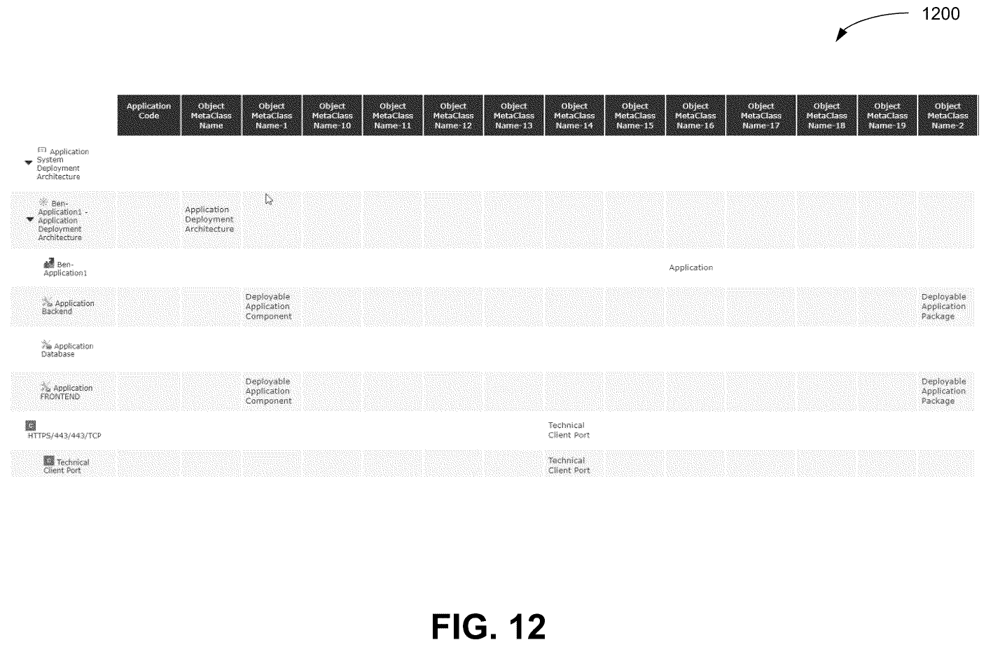

FIG. 12 illustrates an example of created integration data, in accordance with one or more embodiments. The example data of FIG. 12 may be provided and output as an integration data file, for example in a Microsoft Excel format. For example, within the Application System Deployment Architecture in Hopex, the Ben-Application1-Application Deployment Architecture is shown, with the Application Deployment Architecture itself being mapped to a first object name in the threat model with Object MetaClass Name. Sub-elements Application Backend and Application Frontend in the system architecture data are mapped to Deployable Application Component under Object MetaClass Name-1 in the threat model, or threat assessment input, as well as a Deployable Application Package under a different object model in the threat model. The HTTPS/443/443/TCP and the Technical Client Port in the system architecture data are mapped to a Technical Client Port in the threat model under a different object metaclass name. Ben-Application-1 is mapped to an Application object in the threat model.

Embodiments of the present disclosure provide a system and method to integrate software design and a threat assessment tools and operations, for example by including data mapping and providing a translator blueprint. According to one or more embodiments, an integration is provided between a software design tool and a threat assessment tool, such as Hopex and Threat Modeler, to simplify and streamline the work of architects. A data mapping between Hopex and Threat Modeler may be used to create a fast and accurate way to enable assessment of threats. A translation blueprint may be used to build a translator component to ingest a data file and translate contents of the data file into the threat modeler's data model. A data mapping file may be used for translation and integration with Hopex. A tree-like structure of data elements may be used for diagrams and applications. A GraphQL interface may be provided that serves the integration data, which may alternatively be provided via other means, such as making available an Excel or CSV file.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a compact disk read only memory (CD-ROM), digital versatile disk (DVD), Blu-ray Disc Read Only Memory (BD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

Embodiments of the disclosure can be described with reference to the following clauses, with specific features laid out in the dependent clauses:

One aspect of the present disclosure relates to a system configured for enabling automated threat model assessment for a software solution. The system may include one or more hardware processors configured by machine-readable instructions. The processor(s) may be configured to obtain software architecture data from a software design tool, the software architecture data associated with design and deployment of the software solution. The processor(s) may be configured to create, based on the obtained software architecture data, integration data comprising a subset of the software architecture data that is relevant to threat modeling, the integration data formatted for import by a threat assessment tool as threat assessment input data. The processor(s) may be configured to provide, to the threat assessment tool, access to the integration data for use in automated threat assessment.

In some implementations of the system, the processor(s) may be configured to obtain a data extraction blueprint for extracting the subset of the software architecture data. In some implementations of the system, the processor(s) may be configured to create the integration data based on the obtained software architecture data and based on the data extraction blueprint.

In some implementations of the system, the software architecture data may comprise first architecture data sufficient to create a first software architecture in the software design tool associated with the design and deployment of the software solution. In some implementations of the system, the integration data may comprise second architecture data sufficient to re-create the first software architecture in the threat assessment tool associated with the design and deployment of the software solution.

In some implementations of the system, the processor(s) may be configured to create an integration file comprising the integration data. In some implementations of the system, the processor(s) may be configured to provide access to an integration file.

In some implementations of the system, the integration file may be provided in a comma separated variable (CSV) format.

In some implementations of the system, the processor(s) may be configured to provide access to the integration data via an application programming interface (API) data query.

In some implementations of the system, the API data query may comprise a GraphQL query, and the integration data may comprise a GraphQL schema.

Another aspect of the present disclosure relates to a processor-implemented method of enabling automated threat model assessment for a software solution. The method may include obtaining software architecture data from a software design tool, the software architecture data associated with design and deployment of the software solution. The method may include creating, based on the obtained software architecture data, integration data comprising a subset of the software architecture data that is relevant to threat modeling, the integration data formatted for import by a threat assessment tool as threat assessment input data. The method may include providing, to the threat assessment tool, access to the integration data for use in automated threat assessment.

In some implementations of the method, it may include obtaining a data extraction blueprint for extracting the subset of the software architecture data. In some implementations of the method, it may include creating the integration data based on the obtained software architecture data and based on the data extraction blueprint.

In some implementations of the method, the software architecture data may comprise first architecture data sufficient to create a first software architecture in the software design tool associated with the design and deployment of the software solution. In some implementations of the method, the integration data may comprise second architecture data sufficient to re-create the first software architecture in the threat assessment tool associated with the design and deployment of the software solution.

In some implementations of the method, it may include creating an integration file comprising the integration data. In some implementations of the method, it may include providing access to an integration file.

In some implementations of the method, the integration file may be provided in a comma separated variable (CSV) format.

In some implementations of the method, it may include providing access to the integration data via an application programming interface (API) data query.

In some implementations of the method, the API data query may comprise a GraphQL query, and the integration data may comprise a GraphQL schema.

Yet another aspect of the present disclosure relates to a non-transient computer-readable storage medium having instructions embodied thereon, the instructions being executable by one or more processors to perform a method of enabling automated threat model assessment for a software solution. The method may include obtaining software architecture data from a software design tool, the software architecture data associated with design and deployment of the software solution. The method may include creating, based on the obtained software architecture data, integration data comprising a subset of the software architecture data that is relevant to threat modeling, the integration data formatted for import by a threat assessment tool as threat assessment input data. The method may include providing, to the threat assessment tool, access to the integration data for use in automated threat assessment.

In some implementations of the computer-readable storage medium, the method may include obtaining a data extraction blueprint for extracting the subset of the software architecture data. In some implementations of the computer-readable storage medium, the method may include creating the integration data based on the obtained software architecture data and based on the data extraction blueprint.

In some implementations of the computer-readable storage medium, the method may include the software architecture data comprising first architecture data sufficient to create a first software architecture in the software design tool associated with the design and deployment of the software solution. In some implementations of the computer-readable storage medium, the method may include the integration data comprising second architecture data sufficient to re-create the first software architecture in the threat assessment tool associated with the design and deployment of the software solution.

In some implementations of the computer-readable storage medium, the method may include creating an integration file comprising the integration data. In some implementations of the computer-readable storage medium, the method may include providing access to an integration file.

In some implementations of the computer-readable storage medium, the method may include the integration file being provided in a comma separated variable (CSV) format.

In some implementations of the computer-readable storage medium, the method may include providing access to the integration data via an application programming interface (API) data query.

In some implementations of the computer-readable storage medium, the method may include the API data query comprising a GraphQL query, and the integration data comprising a GraphQL schema.

Still another aspect of the present disclosure relates to a system configured for enabling automated threat model assessment for a software solution. The system may include means for obtaining software architecture data from a software design tool, the software architecture data associated with design and deployment of the software solution. The system may include means for creating, based on the obtained software architecture data, integration data comprising a subset of the software architecture data that is relevant to threat modeling, the integration data formatted for import by a threat assessment tool as threat assessment input data. The system may include means for providing, to the threat assessment tool, access to the integration data for use in automated threat assessment.

In some implementations of the system, the system may include means for obtaining a data extraction blueprint for extracting the subset of the software architecture data. In some implementations of the system, the system may include means for creating the integration data based on the obtained software architecture data and based on the data extraction blueprint.

In some implementations of the system, the system may include means wherein the software architecture data comprises first architecture data sufficient to create a first software architecture in the software design tool associated with the design and deployment of the software solution. In some implementations of the system, the integration data comprises second architecture data sufficient to re-create the first software architecture in the threat assessment tool associated with the design and deployment of the software solution.

In some implementations of the system, the system may include means for creating an integration file comprising the integration data. In some implementations of the system, the system may include means for providing access to an integration file.

In some implementations of the system, the integration file may be provided in a comma separated variable (CSV) format.

In some implementations of the system, the system may include means for providing access to the integration data via an application programming interface (API) data query.

In some implementations of the system, the API data query may comprise a GraphQL query, and the integration data may comprise a GraphQL schema.

Even another aspect of the present disclosure relates to a computing platform configured for enabling automated threat model assessment for a software solution. The computing platform may include a non-transient computer-readable storage medium having executable instructions embodied thereon. The computing platform may include one or more hardware processors configured to execute the instructions. The processor(s) may execute the instructions to obtain software architecture data from a software design tool, the software architecture data associated with design and deployment of the software solution. The processor(s) may execute the instructions to create, based on the obtained software architecture data, integration data comprising a subset of the software architecture data that is relevant to threat modeling, the integration data formatted for import by a threat assessment tool as threat assessment input data. The processor(s) may execute the instructions to provide, to the threat assessment tool, access to the integration data for use in automated threat assessment.

In some implementations of the computing platform, the processor(s) may execute the instructions to obtain a data extraction blueprint for extracting the subset of the software architecture data. In some implementations of the computing platform, the processor(s) may execute the instructions to create the integration data based on the obtained software architecture data and based on the data extraction blueprint.

In some implementations of the computing platform, the processor(s) may execute the instructions wherein the software architecture data comprises first architecture data sufficient to create a first software architecture in the software design tool associated with the design and deployment of the software solution. In some implementations of the computing platform, the processor(s) may execute the instructions wherein the integration data comprises second architecture data sufficient to re-create the first software architecture in the threat assessment tool associated with the design and deployment of the software solution.

In some implementations of the computing platform, the processor(s) may execute the instructions to create an integration file comprising the integration data. In some implementations of the computing platform, the processor(s) may execute the instructions to provide access to an integration file.

In some implementations of the computing platform, the processor(s) may execute the instructions wherein the integration file is provided in a comma separated variable (CSV) format.

In some implementations of the computing platform, the processor(s) may execute the instructions to provide access to the integration data via an application programming interface (API) data query.

In some implementations of the computing platform, the processor(s) may execute the instructions wherein the API data query comprises a GraphQL query, and the integration data comprises a GraphQL schema.

What is claimed is:

1. An apparatus configured for enabling automated threat model assessment for a software solution, the apparatus comprising:
a non-transient computer-readable storage medium having executable instructions embodied thereon; and
one or more hardware processors configured to execute the instructions to:
obtain software architecture data from a software design tool, the software architecture data associated with design and deployment of the software solution;
create, based on the obtained software architecture data, integration data comprising a subset of the software architecture data that is relevant to threat modeling, the integration data formatted for import by a threat assessment tool as threat assessment input data; and
provide, to the threat assessment tool, access to the integration data for use in automated threat assessment.

2. The apparatus of claim 1 wherein the one or more hardware processors are further configured to execute the instructions to:
obtain a data extraction blueprint for extracting the subset of the software architecture data; and
create the integration data based on the obtained software architecture data and based on the data extraction blueprint.

3. The apparatus of claim 1 wherein:
the software architecture data comprises first architecture data sufficient to create a first software architecture in the software design tool associated with the design and deployment of the software solution; and
the integration data comprises second architecture data sufficient to re-create the first software architecture in the threat assessment tool associated with the design and deployment of the software solution.

4. The apparatus of claim 1 wherein the one or more hardware processors are further configured to execute the instructions to:
create an integration file comprising the integration data; and
provide access to the integration file.

5. The apparatus of claim 1 wherein the one or more hardware processors are further configured to execute the instructions to:
provide access to the integration data via an application programming interface (API) data query.

6. The apparatus of claim 1 wherein the one or more hardware processors are further configured to execute the instructions to:
obtain a translation blueprint for translating the software architecture data to the threat assessment input data; and
provide the translation blueprint to the threat assessment tool for translating the software architecture data to the threat assessment input data.

7. The apparatus of claim 6 wherein the one or more hardware processors are further configured to execute the instructions to:
provide, as an input to a large language model, a data mapping of stored mapping relationships between software architecture data objects and threat assessment data objects; and
obtain, as an output of the large language model, the translation blueprint.

8. The apparatus of claim 1 wherein the one or more hardware processors are further configured to execute the instructions to:
obtain updated software architecture data from the software design tool, the updated software architecture data associated with design and deployment of an updated version of the software solution;
create, based on the obtained updated software architecture data, updated integration data comprising a subset of the updated software architecture data that is relevant to threat modeling, the updated integration data formatted for import by the threat assessment tool as threat assessment input data; and
provide, to the threat assessment tool, access to the updated integration data for use in automated threat assessment.

9. The apparatus of claim 1 wherein:
the software solution comprises a plurality of applications, and
the software architecture data comprises data associated with the design and deployment of the plurality of applications including interactions between the plurality of applications.

10. A method of enabling automated threat model assessment for a software solution comprising:
obtaining software architecture data from a software design tool, the software architecture data associated with design and deployment of the software solution;
creating, based on the obtained software architecture data, integration data comprising a subset of the software architecture data that is relevant to threat modeling, the integration data formatted for import by a threat assessment tool as threat assessment input data; and
providing, to the threat assessment tool, access to the integration data for use in automated threat assessment.

11. The method of claim 10 further comprising:
obtaining a data extraction blueprint for extracting the subset of the software architecture data; and
creating the integration data based on the obtained software architecture data and based on the data extraction blueprint.

12. The method of claim 10 wherein:
the software architecture data comprises first architecture data sufficient to create a first software architecture in the software design tool associated with the design and deployment of the software solution; and
the integration data comprises second architecture data sufficient to re-create the first software architecture in the threat assessment tool associated with the design and deployment of the software solution.

13. The method of claim 10 further comprising:
creating an integration file comprising the integration data; and
providing access to the integration file.

14. The method of claim 10 further comprising:
providing access to the integration data via an application programming interface (API) data query.

15. The method of claim 10 further comprising:
obtaining a translation blueprint for translating the software architecture data to the threat assessment input data; and
providing the translation blueprint to the threat assessment tool for translating the software architecture data to the threat assessment input data.

16. The method of claim 15 further comprising:
providing, as an input to a large language model, a data mapping of stored mapping relationships between software architecture data objects and threat assessment data objects; and
obtaining, as an output of the large language model, the translation blueprint.

17. The method of claim 10 further comprising:
obtaining updated software architecture data from the software design tool, the updated software architecture data associated with design and deployment of an updated version of the software solution;
creating, based on the obtained updated software architecture data, updated integration data comprising a subset of the updated software architecture data that is relevant to threat modeling, the updated integration data formatted for import by the threat assessment tool as threat assessment input data; and
providing, to the threat assessment tool, access to the updated integration data for use in automated threat assessment.

18. The method of claim 10 wherein:
the software solution comprises a plurality of applications, and
the software architecture data comprises data associated with the design and deployment of the plurality of applications including interactions between the plurality of applications.

19. A non-transient computer-readable storage medium having instructions embodied thereon, the instructions being executable by one or more processors to perform a method of enabling automated threat model assessment for a software solution, comprising:
obtaining software architecture data from a software design tool, the software architecture data associated with design and deployment of the software solution;
creating, based on the obtained software architecture data, integration data comprising a subset of the software architecture data that is relevant to threat modeling, the integration data formatted for import by a threat assessment tool as threat assessment input data; and
providing, to the threat assessment tool, access to the integration data for use in automated threat assessment.

20. The non-transient computer-readable storage medium of claim 19 wherein the method further comprises:
obtaining a translation blueprint for translating the software architecture data to the threat assessment input data; and
providing the translation blueprint to the threat assessment tool for translating the software architecture data to the threat assessment input data.
